(19) United States
(12) Patent Application Publication
(10) Pub. No.: US 2013/0224334 A1
(43) Pub. Date: Aug. 29, 2013

(54) PARTICULATE COATING PROCESSING

(71) Applicants: Mark Jarrard, Morris Plains, NJ (US); Gerald Cotten, Sparta, NJ (US); Cesar Elejalde, Randolph, NJ (US); Thomas Kuncewitch, Long Valley, NJ (US); Frank Luzniak, Succasunna, NJ (US)

(72) Inventors: Mark Jarrard, Morris Plains, NJ (US); Gerald Cotten, Sparta, NJ (US); Cesar Elejalde, Randolph, NJ (US); Thomas Kuncewitch, Long Valley, NJ (US); Frank Luzniak, Succasunna, NJ (US)

(73) Assignee: KRAFT FOODS GLOBAL BRANDS LLC, Deerfield, IL (US)

(21) Appl. No.: 13/861,506

(22) Filed: Apr. 12, 2013

Related U.S. Application Data
(62) Division of application No. 12/277,794, filed on Nov. 25, 2008.
(60) Provisional application No. 60/991,011, filed on Nov. 29, 2007.

(51) Int. Cl. A23G 3/34; A23G 4/20

(52) U.S. Cl. CPC A23G 3/0085; A23G 4/20
USPC 426/5; 426/293

(57) ABSTRACT

The present invention relates to coating of confectionery or chewing gum compositions, products containing the same and methods for preparing. More specifically, the coating compositions of the present invention may include an acid blend. In some embodiments, the coating compositions may be in particulate form.

### CROSS-REFERENCE TO RELATED APPLICATIONS

This application is a divisional application of application Ser. No. 12/277,794 filed Nov. 25, 2008, which claims priority to U.S. Provisional Application No. 60/991,011, filed Nov. 29, 2007, the entire contents of each are incorporated herein by reference.

### FIELD

The present invention is directed generally to coating compositions and products containing the same. More particularly, the present invention relates to particulate coating of confectionery including chewing gum compositions including an acid blend of coating compositions in particulate form.

### BACKGROUND

Coatings may be added to confectionery and chewing gum compositions in order to provide additional colors, flavors, and textures. One desirable coating includes an acidic component which provides a sour taste upon consumption. Such a coating may be present in a solid or particulate coating. Commonly the coating is a sugar and acid mixture in particulate form.

In traditional particulate coating of confectionery compositions, the confectionery is subjected to a steaming method which tackifies the surface of the confectionery product. The tackified product is then coated with a particulate coating composition via any number of methods.

Such steaming methods are not easily adaptable for certain confectioneries, including chewing gums, however, as high temperature steam can cause the confectionery or chewing gum to deform, rendering the piece of confectionery or chewing gum difficult to satisfactorily coat. Thus there is a need for a suitable method of coating certain confectioneries including chewing gum compositions with a particulate coating composition.

### BRIEF DESCRIPTION OF THE DRAWINGS

FIG. 1 is a schematic representation of one method of the present invention.

FIG. 2 is a schematic representation of an alternate method of the present invention.

FIG. 3 is a schematic representation of an alternate method of the present invention.

### SUMMARY

In one embodiment of the present invention, a method of preparing a particulate coated confectionery or chewing gum product is provided. The method includes the steps of: providing a confectionery or chewing gum composition having a surface; applying a surface treatment to the surface; and applying a particulate coating composition to the surface-treated confectionery or chewing gum composition.

In another embodiment of the invention, there is provided a method of preparing a particulate coated confectionery or chewing gum product, the method including the steps of: providing a confectionery or chewing gum composition having at least one surface; heating at least one surface; and applying a particulate coating to at least one heated surface.

In yet another embodiment of the invention, there is provided a method of preparing a coated confectionery or chewing gum product, which includes the steps of: providing a confectionery or chewing gum composition having a surface; exposing the surface to a first pre-conditioning step; exposing the surface to at least a second pre-conditioning step; and applying a particulate coating composition to the pre-conditioned surface.

In some embodiments, a forming step is included in the method of preparing a coated confectionery or chewing gum composition. This forming step can occur prior to or after the particulate coating composition is applied. The forming step can also occur prior to or after the at least one pre-conditioning step.

### DETAILED DESCRIPTION

In some embodiments, there is provided a confectionery and/or chewing gum composition which is at least partially coated with a particulate coating. In some embodiments, there is provided a confectionery and/or chewing gum composition which includes at least one confectionery and/or gum region with at least one external surface. The particulate coating may be applied to any desired surface or surfaces of the confectionery and/or chewing gum composition.

As used herein, the term “confection”, or “confectionery” may include any conventional confectionary composition, such as gummy candy or “gummi” confections (gummy candy includes a hydrocolloid texturizing agent such as gelatin alone or in combination with other texturizing agents). Also included in those chewable forms are soft candies such as, but not limited to, gum drops, licorice, fruit snacks, starch based jellies, gelatin based jellies, pectin based jellies, carageenan based jellies, agar based jellies, konjac based jellies, chewy candy, starch candy, nougat, toffee, taffy, marshmallow, fondant, fudge, chocolate, compound coating, carob coating, caramel, compressed tablets, candy floss (also known as cotton candy), marzipan, hard boiled candy, nut brittles, pastilles, pralines, nonpareils, dragees, lozenges, sugared nuts, comfits, aniseed balls, nougatine, and jelly beans. Also included in those chewable forms are chewing gums including bubble gums. In some embodiments, the confectionery is selected from the group consisting of chewy candy, gummy candy, marshmallow, chewing gum, and combinations thereof.

As used herein, the term “confectionery region” or “gum region” refers to a region of a center-fill confectionery product, which may be adjacent to or at least partially surrounding the center-fill, or innermost, region. In some embodiments, the confectionery region is an intermediate region.

As used herein, the term “center-fill” refers to the innermost region of a center-fill confection. The term “center-fill” does not necessarily imply symmetry of a confectionery product, only that the “center-fill” is within another region of the product. In some embodiments, the center-fill may be substantially symmetric and in others, the center-fill may not be symmetric of the confectionery piece. In some embodiments, more than one center-fill may be present. A center-fill may include solid, liquid, gas and mixtures thereof. The term “liquid” in the context of a center-fill includes fluid materials as well as semi-solid or gel materials. The center-fill can be aqueous, non-aqueous, or an emulsion.

As used herein, the terms “coating” or “coating region” are used to refer to the outermost region of a confectionery product. In some embodiments, the coating may be amorphous or crystalline and it may be continuous or discontinuous. Particulate coatings may be referred to as “sanding” compositions or “dusting” compositions. Confections with such particulate coatings may be referred to as sanded or dusted.

As used herein, the terms “surround,” “surrounding,” and the like are not limited to encircling. These terms may refer to enclosing or confining on all sides, encircling or enveloping, and are not limited to symmetrical or identical thicknesses for a region in a center-fill confectionery product.

Encapsulating material for encapsulating the encapsulated ingredient includes any one or more water soluble or water insoluble polymers, co-polymers, or other materials capable of forming a coating, shell, or film as a protective barrier or layer around one or more ingredients and/or capable of forming a matrix with the one or more ingredients. In some embodiments, the encapsulating material may completely surround, coat, cover, or enclose an ingredient. In other embodiments, the encapsulating material may only partially surround, coat, cover, or enclose an ingredient.

### Particulate Coating Composition

In some embodiments a particulate coating is provided. The particulate coating preferably includes a sweetener and a food acid. The particulate coating may include any food acid desired, including an acid blend of lactic acid, tartaric acid, fumaric acid, or combinations thereof. One advantage of an acid blend is that it provides a significantly more tart or sour perception to a consumer as compared to an equivalent amount of citric acid. In some embodiments a particulate coating is provided which may include at least one encapsulated ingredient. The particulate coating may be applied to a surface of the confectionery and/or chewing gum composition. In some embodiments, a surface of a confectionery and/or chewing gum composition is surface treated prior to application of the particulate coating, which will be described in more detail below.

The acid blend preferably includes lactic acid, which may also be present as calcium lactate or a blend of lactic acid with calcium lactate. Also included in the acid blend are tartaric acid and fumaric acid. The acid blend provides a more intense sour perception than an equivalent amount of citric acid. If desired, citric acid and other components may also be included in the acid blend. Each of the acid components may be present in any amount to provide the desired taste. For example, lactic acid may be present in an amount from about 50% to about 65%, or more specifically from about 55% to about 60% by weight of the acid blend, tartaric acid may be present in an amount from about 30% to about 45%, or more specifically from about 35 to about 40%, by weight of the acid blend, and fumaric acid may be present in an amount from about 1% to about 10%, or more specifically from about 2% to about 6% by weight of the acid blend.

The acid blend may be combined with sweeteners including, but not limited to, sugar bulk sweeteners, polyol bulk sweeteners, high intensity sweeteners, or combinations to provide the acidic particulate coating. The acid blend may be present in the coating in any desired amount, specifically from about 5% to about 20% by weight of the coating, more specifically about 10% by weight of the coating. The sweetener component may also be used in any desired amount to provide a 100% total weight in combination with the acid blend. Specifically, sweetener may be used in an amount from about 85% to about 90% by weight of the acidic particulate coating. Additionally, the sweetener component may be provided in any suitable particle size and/or particle size distribution to create a desired texture. The particulate coating composition may optionally include an adhesive syrup to hold the particulate coating composition together and/or bind the particulate coating to the surface of the confectionery and/or chewing gum piece.

As used herein, the term “sweetener” or refers to any ingredient that provides sweetness and includes bulk sweeteners, high intensity sweeteners, or combinations thereof. As used herein, the term “sugar” or “sugar saccharide” or “sugar bulk sweetener” refers to, but is not limited to, mono-saccharides, di-saccharides and poly-saccharides such as but not limited to, sucrose, dextrose, maltose, dextrin, xylose, ribose, glucose, mannose, galactose, sucromalt, fructose (levulose), invert sugar, corn syrups, maltodextrins, fructo oligo saccharide syrups, partially hydrolyzed starch, corn syrup solids, polydextrose, soluble fibers, insoluble fibers, and mixtures thereof. As used herein, the term “polyol” or “polyol bulk sweetener” or “polyol saccharide” or “sugarless bulk sweetener” refers to, but is not limited to, sugar alcohols (or polyols) such as, but not limited to, sorbitol, xylitol, mannitol, galactitol, maltitol, hydrogenated isomaltulose (ISOMALT), lactitol, erythritol, hydrogenated starch hydrolysates, maltitol syrups, and mixtures thereof. As used herein, “high intensity sweetener” refers to sweetener ingredients that provide a sweetness intensity greater than sucrose when compared on a weight per weight basis. High intensity sweeteners are described further below.

The particulate coating composition may include any conventional ingredient such as, but not limited to, sweeteners, flavors, sensates, functional ingredients, and food acids. In some embodiments, the coating composition may be in particulate form, crystalline form, or amorphous form. In some embodiments, the particulate coating composition may be continuous or discontinuous. In some embodiments, the particulate coating may completely surround, coat, cover, or enclose a confectionery piece. In other embodiments, the particulate coating may only partially surround, coat, cover, or enclose a confectionery piece.

The selection of the form of the particulate coating composition may depend on the desired texture of the confectionery composition.

In some embodiments, the particulate coating composition may include one or more sweeteners, and/or one or more flavors, and/or one or more sensates, and/or one or more salts, and/or one or more functional ingredients, and/or one or more food acids. In some embodiments, the one or more sweeteners, and/or one or more flavors, and/or one or more sensates, and/or one or more functional ingredients, and/or one or more food acids may be encapsulated, unencapsulated (or “free”) or a combination of encapsulated and unencapsulated.

In still other embodiments, the particulate coating composition may include one or more sweeteners, and/or one or more flavors, and/or one or more sensates, and/or one or more salts, and/or one or more functional ingredients, and/or one or more food acid materials with similar particle sizes such that if they are mixed together, they form a homogeneous blend.

In embodiments where the coating is in particulate form, the food acid or flavor or sensate or sweetener or salt or functional ingredient materials may be present in an amount from about 0.05% by weight to about 20% by weight, preferably from about 5% by weight to about 15% by weight of the coating composition.

In some embodiments, the particulate coating may also include a sugar saccharide or polyol bulk sweetener or a combination of sugar saccharide and polyol bulk sweetener. Suitable sugar saccharides may include, but are not limited to, mono-saccharides, di-saccharides and poly-saccharides such as but not limited to, sucrose (sugar saccharide), dextrose, maltose, dextrin, xylose, ribose, glucose, mannose, galactose, sucromalt, fructose (levulose), invert sugar, corn syrups, maltodextrins, fructo oligo saccharide syrups, partially hydrolyzed starch, corn syrup solids, polydextrose, soluble fibers, insoluble fibers, and mixtures thereof.

Suitable polyols may include, but are not limited to sugar alcohols (or polyols) such as, but not limited to, sorbitol, xylitol, mannitol, galactitol, maltitol, hydrogenated isomaltulose (ISOMALT), lactitol, erythritol, hydrogenated starch hydrolysates, maltitol syrups, and mixtures thereof.

Suitable hydrogenated starch hydrolysates include those disclosed in U.S. Pat. No. 4,279,931 and various hydrogenated glucose syrups and/or powders which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric polyol saccharides. The ratios of these different polyol saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In some embodiments, the coating composition may be included in the confectionery or chewing gum composition in amounts from about 1% by weight of the total composition to about 75% of the total composition. In some embodiments, the coating composition may be included in the coated confectionery or chewing gum composition in amounts from about 5% by weight of the total composition to about 15% by weight of the total composition.

In some embodiments, particulate coated confectionery products may include a center-fill region. The moisture content of a center-filled confectionery may be greater than the moisture content of a confection without a center-filling. In some embodiments, the higher moisture content of a center-filled confectionery may create a need for a coating that will not pull moisture out of the confection. In such embodiments, it may be more desirable to partially or completely encapsulate an ingredient used in a confectionery composition with an encapsulating material to stabilize the ingredient against moisture absorption and/or moisture migration.

In some embodiments, the particulate coating composition may include a range of particle sizes. Any particle size may be used, depending on the texture and user sensation desired. In preferred embodiments, the particulate coating includes particles having an average particle size of about 10-200 microns. Any particle sizes may be used to achieve the desired particulate coating texture and look. A coating composition having a small average particle size (approximately 50 microns) will provide a less grainy feel than a coating composition having a larger average particle size (approximately 150 microns). In some embodiments, the particulate coating composition may include particles having an average particle size of about 10-60 microns, while in other embodiments the coating composition may include particles having an average particle size of about 60-120 microns. In still other embodiments, the coating composition may include particles having an average particle size of about 120-200 microns. In still other embodiments, the particulate coating composition may include a certain percentage of particles having an average particle size of about 10-60 microns, a certain percentage of particles having an average particle size of about 60-110 microns, and a certain percentage of particles having an average particle size of about 110-200 microns. In one embodiment, each range of particle sizes may be present in an amount of about 33% of the coating composition.

### Ingredients

### Sweeteners:

Sweeteners can include sugar bulk sweeteners, sugarless bulk sweeteners, or the like, high intensity sweeteners, or mixtures thereof. Bulk sweeteners generally are present in amounts of about 5% to about 99% by weight of the confectionery or chewing gum composition. Suitable sugar bulk sweeteners generally include mono-saccharides, di-saccharides and poly-saccharides such as but not limited to, sucrose (sugar), dextrose, maltose, dextrin, xylose, ribose, glucose, mannose, galactose, fructose (levulose), invert sugar, sucromalt, corn syrups, maltodextrins, oligo saccharide syrups, fructo oligo saccharide syrups, partially hydrolyzed starch, corn syrup solids, resistant starches, and mixtures thereof.

Suitable sugarless bulk sweeteners include sugar alcohols (or polyols) such as, but not limited to, sorbitol, xylitol, mannitol, galactitol, maltitol, hydrogenated isomaltulose (ISOMALT), lactitol, erythritol, hydrogenated starch hydrolysates, and mixtures thereof.

Suitable hydrogenated starch hydrolysates include those disclosed in U.S. Pat. No. 4,279,931 and various hydrogenated glucose syrups and/or powders which contain sorbitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric polyol saccharides. The ratios of these different polyol saccharides give different hydrogenated starch hydrolysates different properties. Mixtures of hydrogenated starch hydrolysates, such as LYCASIN® a commercially available product manufactured by Roquette Freres of France, and HYSTAR®, a commercially available product manufactured by SPI Polyols, Inc. of New Castle, Del., are also useful.

In some embodiments, high-intensity sweeteners also may be included as sweetening agents in the confectionery or chewing gum compositions. High intensity sweeteners may be used in conjunction with or as an alternative to sugar and sugarless bulk sweeteners described above. Without being limited to particular sweeteners, representative categories and examples include:

(a) water-soluble sweetening agents such as dihydrochalcones, monellin, steviosides and stevia derived compounds such as but not limited to rebaudiocide A, iso-mogroside V and the like, lo han quo and lo han quo derived compounds, glycyrrhizin, dihydroflavenol, and sugar alcohols such as sorbitol, mannitol, maltitol, xylitol, erythritol, and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame), N-[N-(3,3-dimethylbutyl)-L-.alpha.-aspartyl]-L-phenylalanine 1-methyl ester (Neotame), and materials described in U.S. Pat. No. 3,492,131, L-alphaaspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose or Splenda™; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideo-xy-beta-D-fructofuranoside, or 4,6,1′,6′-tetrachloro-4,6,1′,6′-tetradeoxygalacto-sucrose; and 4,6,1′,6′-tetradeoxy-sucrose, and mixtures thereof;

(e) protein based sweeteners such as miraculin, extracts and derivatives of extracts of Synseplum dulcificum, mabinlin, curculin, monellin, brazzein, pentadin, extracts and derivatives of extracts of Pentadiplandra brazzeana, thaumatin, thaumaoccous danielli (Thaumatin I and II) and talin;

(f) the sweetener monatin (2-hydroxy-2-(indol-3-ylmethyl)-4-aminoglutaric acid) and its derivatives or isomers; and

(g) the sweetener Lo han guo (sometimes also referred to as “Lo han kuo”) and its derivatives.

The intense sweetening agents may be used in many distinct physical forms well-known in the art to provide an initial burst of sweetness and/or a prolonged sensation of sweetness. Without being limited thereto, such physical forms include free forms, spray dried forms, powdered forms, beaded forms, encapsulated forms, and mixtures thereof. In one embodiment, the sweetener is a high intensity sweetener such as aspartame, sucralose, and acesulfame potassium (e.g., Ace-K or acesulfame-K).

In some embodiments, the sweetener may be a polyol. Polyols can include, but are not limited to glycerol, sorbitol, maltitol, maltitol syrup, mannitol, isomalt, erythritol, xylitol, hydrogenated starch hydrolysates, polyglycitol syrups, polyglycitol powders, lactitol, and combinations thereof.

The sweetener may be used in amounts necessary to impart the desired effect associated with use of the active component (e.g., sweetness). In general, an effective amount of intense sweetener may be utilized to provide the level of sweetness desired, and this amount may vary with the sweetener selected. The intense sweetener may be present in amounts from about 0.001% to about 3%, by weight of the composition, depending upon the sweetener or combination of sweeteners used. The exact range of amounts for each type of sweetener may be selected by those skilled in the art.

In some embodiments wherein a high intensity sweetener is included, the sweetener may be sucralose, saccharin salts, acesulfame potassium, aspartame, thaumatin, monatin (2-hydroxy-2-(indol-3-ylmethyl)-4-amino glutaric acid), neotame, alitame, and combinations thereof.

Flavors (Including Flavor Potentiators):

In some embodiments, flavorants may include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya and so forth. Other potential flavors whose release profiles may be managed include a milk flavor, a butter flavor, a cheese flavor, a cream flavor, and a yoghurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with the cooling agents, described herein below.

In some embodiments, flavoring agents are used at levels that provide a perceptible sensory experience, i.e. at or above their threshold levels. In other embodiments, flavoring agents are used at levels below their threshold levels such that they do not provide an independent perceptible sensory experience. At subthreshold levels, the flavoring agents may provide an ancillary benefit such as flavor enhancement or potentiation.

In some embodiments, the flavoring agents may be used in many distinct physical forms. Without being limited thereto, such physical forms include free forms, such as spray dried, powdered, beaded forms, encapsulated forms, and mixtures thereof.

Potentiators may consist of materials that may intensify, supplement, modify or enhance the taste and/or aroma perception of an original material without introducing a characteristic taste and/or aroma perception of their own. In some embodiments, potentiators designed to intensify, supplement, modify, or enhance the perception of flavor, sweetness, tartness, umami, kokumi, saltiness and combinations thereof may be included.

In some embodiments, examples of suitable potentiators, also known as taste potentiators include, but are not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, compositions comprising 5′-nucleotides such as those disclosed in US 2006/0078972 to Noordam et al, which is incorporated in its entirety herein by reference, sugar beet extract (alcoholic extract), sugarcane leaf essence (alcoholic extract), curculin, strogin, mabinlin, gymnemic acid, hydroxybenzoic acids, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. “Kokumi” refers to materials that impart “mouthfulness” and “good body”.

Sweetener potentiators, which are a type of taste potentiator, enhance the taste of sweetness. In some embodiments, exemplary sweetener potentiators include, but are not limited to, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, hydroxybenzoic acids, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs) and combinations thereof.

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

### Sensates:

Sensate compounds may include cooling agents, warming agents, tingling agents, effervescent agents, and combinations thereof. A variety of well known cooling agents may be employed. For example, useful cooling agents may include xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3-(1-menthoxy)propane-1,2-diol, 3-(1-menthoxy)-2-methyl propane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-5, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

In some embodiments, warming components may be selected from a wide variety of compounds known to provide the sensory signal of warming to the user. These compounds offer the perceived sensation of warmth, particularly in the oral cavity, and often enhance the perception of flavors, sweeteners and other organoleptic components. In some embodiments, useful warming compounds may include vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyleather, vanillyl alcohol n-hexyleather, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine, and combinations thereof.

In some embodiments, a tingling sensation may be provided. One such tingling sensation is provided by adding jambu oleoresin, or spilanthol to some examples. In some embodiments, alkylamides extracted from materials such as jambu or sanshool may be included. Additionally, in some embodiments, a sensation is created due to effervescence. Such effervescence is created by combining an alkaline material with an acidic material. In some embodiments, an alkaline material may include alkali metal carbonates, alkali metal bicarbonates, alkaline earth metal carbonates, alkaline earth metal bicarbonates and mixtures thereof. In some embodiments, an acidic material may include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of “tingling” type sensates may be found in U.S. Pat. No. 6,780,443, the entire contents of which are incorporated herein by reference for all purposes.

Sensate components may also be referred to as “trigeminal stimulants” such as those disclosed in U.S. Patent Application No. 2005/0202118, which is incorporated herein by reference. Trigeminal stimulants are defined as an orally consumed product or agent that stimulates the trigeminal nerve. Examples of cooling agents which are trigeminal stimulants include menthol, WS-3, N-substituted p-menthane carboxamide, acyclic carboxamides including WS-23, WS-5, WS-14, methyl succinate, and menthone glycerol ketals. Trigeminal stimulants may also include flavors, tingling agents, Jambu extract, vanillyl alkyl ethers, such as vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin and menthol glycerin ether, unsaturated amides, and combinations thereof. Other cooling compounds may include derivatives of 2,3-dimethyl-2-isopropylbutyric acid such as those disclosed in U.S. Pat. No. 7,030,273, which is incorporated herein by reference.

In addition to trigeminal nerve stimulants and cooling compounds, a cooling sensation may be provided by materials exhibiting a negative heat of solution including, but not limited to, dextrose and polyols such as xylitol, erythritol, isomalt, and sorbitol, and combinations thereof.

In some embodiments, sensate components are used at levels that provide a perceptible sensory experience i.e. at or above their threshold levels. In other embodiments, sensate components are used at levels below their threshold levels such that they do not provide an independent perceptible sensory experience. At subthreshold levels, the sensates may provide an ancillary benefit such as flavor or sweetness enhancement or potentiation.

### Functional Ingredients

Functional ingredients as discussed above and such as, but not limited to, medicaments, nutrients such as vitamins and minerals and the like, nutraceuticals such as phytochemicals and the like, breath freshening agents, oral care agents, probiotic materials, prebiotic materials, taste and/or flavor potentiators, and throat care agents.

### Acids

In addition to the acidic particulate coating, the confectionery or chewing gum composition may contain acids, if desired. In some embodiments, the food acid materials are selected such that they provide a sour taste intensity of at least 4 on a scale from 0 to 10. Scales that may be used to measure sour taste have been developed by several sensory researchers. One example of a scale has been developed by Dr. Howard Moskowitz and is discussed in the journal article entitled Sourness of Acid Mixtures as published in The Journal of Experimental Psychology, April 1974; 102(4); 640-7 and in the journal article entitled Ration Scales of Acid Sourness as published in Perception and Psychophysics; 9:371-374, 1971.

### Confectionery Compositions

In some embodiments, the confectionary composition may include, but is not limited to, starch-based jelly candy, gelatin based jelly candy (also known as gummy or gummi candy), pectin based jelly candy (also known as jelly candy), carageenan based jelly candy, hard candies, lozenges, as well as other chewy candies such as marshmallows, taffies, caramels and licorice. Also included in those chewable candy forms are soft candies such as, but not limited to, gum drops, licorice, fruit snacks, starch based jellies, gelatin based jellies, pectin based jellies, carageenan based jellies, agar based jellies, konjac based jellies, chewy candy, starch candy, nougat, toffee, taffy, marshmallow, fondant, fudge, chocolate, compound coating, carob coating, caramel, compressed tablets, candy floss (also known as cotton candy), marzipan, hard boiled candy, nut brittles, pastilles, pralines, nonpareils, dragees, lozenges, sugared nuts, comfits, aniseed balls, nougatine, and jelly beans. The base of the confectionery may be a sugar/glucose syrup combination or a polyol/polyol syrup combination and a gelatinizing agent, the latter of which may be gelatin, agar, gum arabic, maltodextrin, pectin, modified starches or combinations thereof. Various other gums (also referred to as hydrocolloids) may also be used. The gelatinizing material may be desirably dissolved in water or otherwise hydrated prior to mixing with the sugar/glucose syrup combination. If a hydrocolloid such as pectin is used as the gelatinizing agent, then the pectin is desirably dry mixed with a portion of the sugar or bulk sweetener prior to addition of the dry mixture to water.

In some embodiments, the confectionery composition is selected from the group consisting of chewy candy, gummy candy, marshmallow, chewing gum, and combinations thereof.

Bulk sweeteners generally are present in amounts of about 5% to about 99% by weight of the confectionery composition.

In some embodiments, the confectionery compositions may include multi-region confections such as center-filled or layered confections. The chewing gum compositions may include any form of chewing gum, such as, slab, pellet, sticks, center-fill gums, bubble gums, candy gums, multi-region gums, and multi-layer gums.

In some embodiments, a gummy candy composition is provided. The gummy candy confectionery composition may include a particulate coating composition and a confectionery composition including a gummy candy composition. The gummy candy composition may include any conventional gummy candy material such as, but not limited to, sweeteners, hydrocolloids, and food acids. For the hydrocolloid materials, in some embodiments, a desired texture is created by using hydrocolloids that form chewable gels when combined with the other ingredients in the gummy candy composition.

In some embodiments, pectin and gelatin may be used together in a gummy candy composition as described in U.S. application Ser. No. 10/977,585, filed Oct. 28, 2004 and incorporated herein for all purposes.

In some embodiments, the gummy candy composition may contain sweeteners in amounts from about 35% w/w to about 75% w/w of the gummy candy composition. In some embodiments, the gummy candy composition may contain from about 0.01% w/w to about 15% w/w, and preferably from about 1% to about 8% w/w of hydrocolloids. In some embodiments, the gummy candy composition may contain from about 0.3% to about 3%, and preferably from about 0.5% w/w/ and about 2.0% w/w food acids.

In some embodiments, the gummy candy composition can also include buffering agents, coloring, flavoring, and preservatives.

Further, in some embodiments, the gummy candy composition can include any functional ingredients as discussed above.

In some embodiments, the gummy candy composition can include flavors and/or sensates as discussed above.

In some embodiments, the gummy candy composition can be included in a particulate coated gummy candy composition in amounts from about 70 percent by weight of the total composition to about 95 percent by weight of the total composition.

### Chewing Gum Compositions

The confectionery may be a chewing gum composition. Chewing gum compositions may be provided in a variety of different forms, such as, for example, slabs, pellets, sticks, cylinders, chunks, ropes, strings, balls, cubes, center-fill gums, candy gums, multi-region gums, multi-layer gums, bubble gums, deposited gums and compressed gums. The chewing gum compositions also may include at least one flavor and a variety of optional additives.

The chewing gum composition also may include a gum base. The gum base may include any component known in the chewing gum art. Such components may be water soluble, water-insoluble or a combination thereof. For example, the gum base may include elastomers, bulking agents, waxes, elastomer solvents, emulsifiers, plasticizers, fillers and mixtures thereof.

### Moisture Barrier Layer

In some embodiments, an moisture resistant barrier layer is provided, which may prevent moisture migration between the confectionery or chewing gum composition and the particulate coating. The barrier layer may be an intrinsic moisture resistant barrier layer or it may be an external moisture resistant barrier layer. The intrinsic moisture resistant barrier layer may include a crystalline form of a saccharide or polyol. In some embodiments, the intrinsic moisture resistant barrier layer is formed when saccharides or polyols in the chewing gum composition crystallize at the surface of the confectionery or chewing gum composition. In some embodiments, the extrinsic moisture barrier layer may include a shellac or other coating surrounding the confectionery composition.

In some embodiments, to aid the process of crystallization, the amount of crystallizing saccharide or polyol in the confectionery or chewing gum composition may be increased as compared to chewing gum compositions without intrinsic moisture resistant barrier layers.

For example, the amount of sucrose in a chewing gum composition may be increased from 70% glucose to 30% sucrose to 50% glucose to 50% sucrose. This increase in the relative amount of sucrose may aid in the formation of a crystalline sucrose intrinsic moisture resistant barrier layer.

In other embodiments, the process of crystallization may be aided by the application of seed crystals to the surface of the confectionery or chewing gum composition by nucleating the saccharide or polyol contained in the confectionery or chewing gum composition.

In some embodiments, seed crystals may be included in a molding composition that comes in contact with the confectionery or chewing gum composition. Molding composition may include starch. The process of molding may include drying the starch containing molding composition to a desired moisture level and placing it in trays. Impressions may then be created in the starch trays after which the chewing gum composition may be filled into the impressions. After allowing the confectionery or chewing gum composition to reach a desired firmness, the confectionery or chewing gum composition is separated from the molding composition and further processed, packaged, etc.

In another example, seed crystals of erythritol may be included in the starch used for starch molding an erythritol-containing confectionery or chewing gum composition. These seed crystals may aid in the formation of a crystalline erythritol intrinsic moisture resistant barrier layer.

In some embodiments, the confectionery or chewing gum product may be formed into a shape that communicates the nature of the taste and/or flavor of the candy. For example, a confectionery or chewing gum product with a strawberry flavor may be formed by molding into the shape of a strawberry. In other embodiments, the candy may be formed into a shape that does not communicate the taste and/or flavor of the candy. For example, a strawberry flavored confectionery or chewing gum product may be formed by molding into the shape of a pineapple. Such contrasting taste and visual cues may increase the play value of the confectionery or chewing gum.

Similarly, the multiple regions of the confectionery or chewing gum product can be modified to achieve desired visual effects. For example, one color may be included in the coating composition while different colors are included in the chewing gum region and center-fill compositions. In some embodiments the opacity of the regions may differ to provide other visual effects. For example, the center-fill may be opaque while the chewing gum region may be transparent and the coating may be translucent. Different opacities may be combined with the same or different colors for still more visual effects.

### Application of Particulate Coating to Surfaces of Compositions

The particulate coating composition can be applied to the confectionery or chewing gum composition by any conventional means known to those of ordinary skill in the art. In some embodiments, the coating composition including free and/or encapsulated ingredients is in particulate form. In some embodiments, the surface of the chewing gum composition is exposed to at least one pre-conditioning step. In some embodiments, the chewing gum composition may be subjected to a first pre-conditioning step, and then further subjected to at least a second pre-conditioning step. The first and at least second pre-conditioning steps may be the same step or they may be different. In some embodiments, one of the first or second pre-conditioning steps may be a surface treatment to the surface, as will be described below.

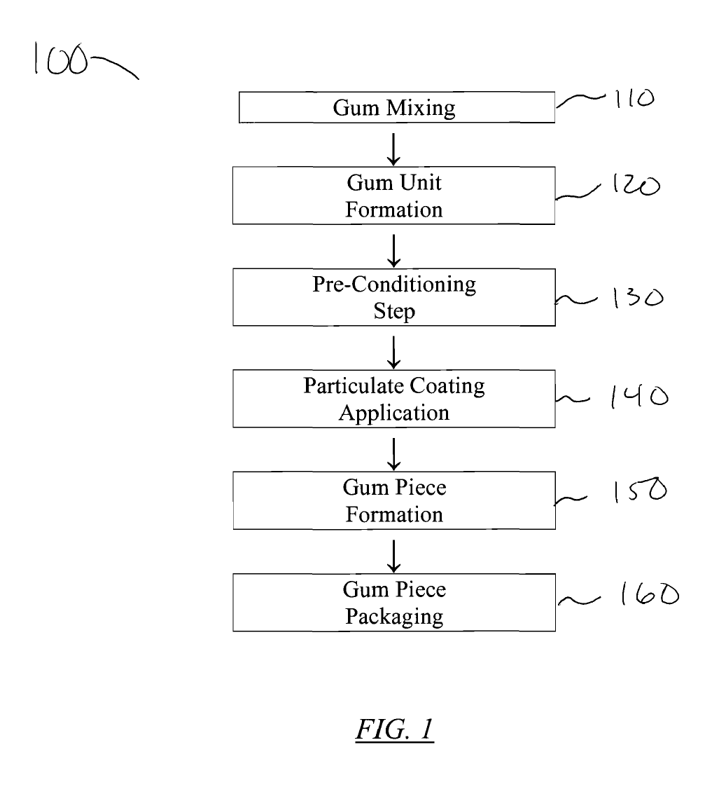

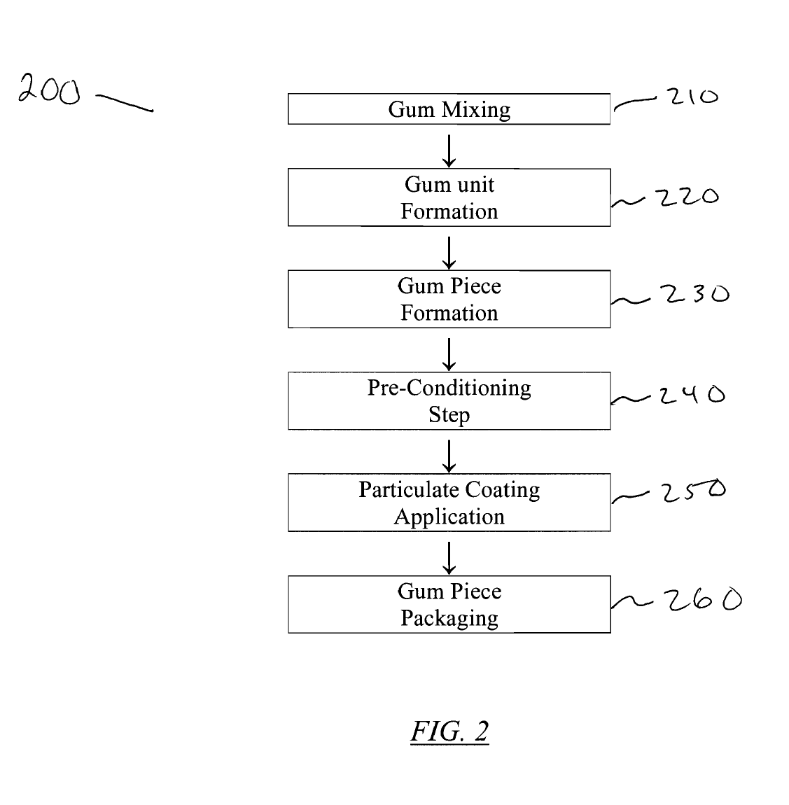

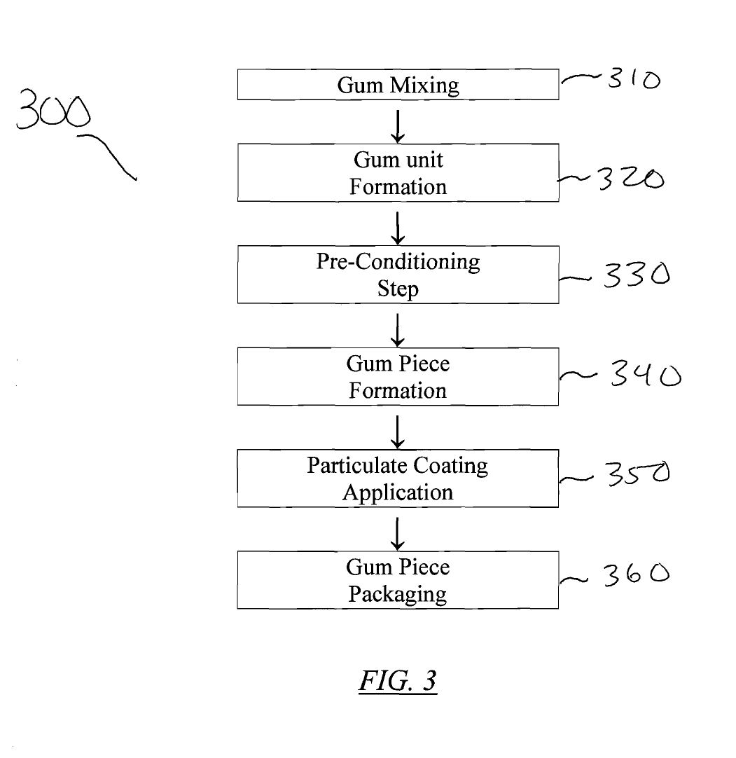

With reference to FIG. 1, one embodiment of the invention is shown. In this embodiment, the preparation of a coated chewing gum composition 100 includes the step 110 of mixing the chewing gum; the step 120 of forming the gum unit; the pre-conditioning step 130; the step 140 of applying the particulate coating to the surface of the gum unit; the step 150 of forming the individual chewing gum pieces; and the step 160 of packaging the gum pieces. As can be seen in FIG. 2, an alternate embodiment of the invention is shown. In this alternate embodiment, the preparation of the gum composition 200 includes the step 210 of mixing the chewing gum; the step 220 of forming the gum unit; the step 230 of forming the individual chewing gum pieces; the pre-conditioning step 240; the step 250 of applying the particulate coating to the surface of the chewing gum piece; and the step 260 of packaging the chewing gum piece. As can be seen in FIG. 3, another alternate embodiment of the invention is shown. In this alternate embodiment, the preparation of the gum composition 300 includes the step 310 of mixing the chewing gum; the step 320 of forming the gum unit; the pre-conditioning step 330; the step 340 of forming the individual chewing gum pieces; the step 350 of applying the particulate coating to the surface of the chewing gum piece; and the step 360 of packaging the chewing gum piece.

Reference will now be made to the method depicted in FIG. 1, but it will be understood that the below description is applicable to other embodiments, including that described in FIG. 1. Further, it will be understood that the method described in FIG. 1 may be applicable to confectionery compositions that do not include chewing gum. The first step 110 is mixing the chewing gum composition, followed by the step 120 of forming the gum unit. The pre-conditioning step 130 may include the application of a surface treatment. As used herein, a surface treatment application process is the process of increasing adherence to surface, such as by application of heat to the surface, applying an external substance or material to the surface, including, but not limited to applying aqueous binders, non-aqueous binders, moisture treatments, and combinations thereof. By subjecting the surface to a surface treatment application, the surface will adequately allow the particulate coating composition to adhere to the treated surface. As used herein, a “moisture treatment” includes exposing the surface of the confectionery product to an effective amount of water, so as to add a level of adhesion to the surface. Any number of surface treatments may be applied to the chewing gum composition to prepare the surface, including, but not limited to a moisture treatment, an aqueous binder treatment, a non-aqueous binder treatment, and combinations thereof. The surface treatment may be applied to the whole surface of the composition, or it may only be applied to certain surfaces of the composition. In some embodiments, there may be more than one surface preparation treatment applied to the chewing gum surface. For example, there may be a first surface treatment followed by a second surface treatment.

In one particular embodiment, the pre-conditioning step 130 includes applying an aqueous binder solution or a non-aqueous binder solution to the desired surface or surfaces of the chewing gum. Once the aqueous binder solution or non-aqueous binder solution is applied to the desired surface, it may optionally be dried for a sufficient time and temperature. In a preferred embodiment, the aqueous-coated chewing gum is dried for about 1 to about 60 seconds. Preferably the solution-coated chewing gum composition is dried for between about 30 to about 60 seconds. The optional drying step aids in removing excess moisture to leave the surface of the chewing gum tacky. In some embodiments, it may be desired to skip the optional drying step, leaving more moisture present on the surface or surfaces of the chewing gum composition. Once the pre-conditioning step 130 has been completed, the step 140 of applying the particulate coating composition to the surface of the treated chewing gum may be performed.

The binder solution may be any desired aqueous binder. In a preferred embodiment, an aqueous binder solution is used which includes dextrin, sugar and water. Other components may be included if desired, including, for example, color and flavors. In one embodiment, the aqueous binder solution includes about 5% to about 30% dextrin, about 20% to about 60% water, and about 20% to about 60% sugar. Other embodiments may include water-based shellacs, saccharides, hydrocolloids and water. Non-aqueous binder solutions may be used if desired. For instance, non-aqueous wetting syrups may include 0-25% water, resins, fats, waxes, liquid oils and combinations thereof. In addition, the non-aqueous wetting syrup may include a solvent based shellac. Optionally, a combination of aqueous and non-aqueous solutions may be used in the surface treatment step(s).

In some embodiments, the tackiness of a chewing gum surface to which a non-aqueous wetting syrup has been applied can be manipulated by varying the concentration of the non-aqueous components in the wetting syrup. In some embodiments, a more concentrated wetting syrup will adhere larger particle sized particles. In some embodiments, a more dilute wetting syrup will adhere smaller particle sized particles.

The binder solution may be applied to a surface of the chewing gum composition by any means desired. For example, the binder solution may be sprayed onto the surface of the chewing gum composition. In other embodiments, the binder solution may be enrobed around the chewing gum composition, or it may be painted onto the desired surface of the chewing gum composition using either contact or non-contact methods. In other embodiments, the binder solution may be applied to the surface of the chewing gum composition by traditional panning methods. If desired, the binder solution may be applied to the surface of the chewing gum composition by dipping the chewing gum composition, or by screw conveying the chewing gum composition. If desired, the binder solution may be applied to one or more surfaces of the composition in a pattern or in other specific locations. Thus, the binder solution may be applied to the surface to create a symbol, letter, number, design, or any desired pattern. Combinations of the aforementioned methods of applying the binder solution may be applied, if desired.

In other embodiments, the pre-conditioning step 130 may include heating at least one surface of the chewing gum composition. The step of heating the surface may take place in addition to the application of a binder solution, or in the absence of the application of a binder solution. For example, the desired surface or surfaces may first be subjected to heat, and then the step 140 of applying the particulate coating composition to the heated surface may be performed. In other embodiments, a binder solution may be applied to the desired surface or surfaces, either prior to heating or after heating the surface or surfaces of the chewing gum composition.

The step of heating at least one surface of the chewing gum composition may be accomplished by any desired means. For example, the step of heating at least one surface may include extruding the chewing gum composition via a heated extruder. In some heated extruder embodiments, the heating step can heat the chewing gum surface to temperatures of from about 18° C. to about 60° C. In a preferred embodiment, the chewing gum surface is heated to from about 35° C. to about 50° C. In another embodiment, the step of heating the surface of the chewing gum composition includes applying localized heat to the desired surface or surfaces of the chewing gum composition. Any desired means to apply localized heat to the surface or surfaces of the chewing gum composition may be used. As with the application of binder solution, heat may be applied in any desired pattern, design, shape, or image. In some localized heating embodiments, the chewing gum composition surface is exposed to temperatures of 70° C.-500° C. for a period of 0.1 second-120 seconds. To avoid excessive melting or deformation of the chewing gum composition surface, there may be an inverse relationship between the temperature of the heat treatment and the time of exposure such that higher temperatures are used for shorter times.

The optional step 150 of forming the chewing gum composition into individual pieces may be performed, if desired. Any desired means to form the individual pieces may be used, including, but not limited to extrusion, rolling, scoring, rope cutting, casting, molding, and combinations thereof. As discussed above, the chewing gum composition may be formed into any shape or form desired. With reference to FIG. 2, in some embodiments, the step 230 of forming the individual chewing gum pieces may occur prior to the pre-conditioning step 240. In such embodiments, the individual pieces of chewing gum are first formed 230, and then the pieces are subjected to the desired pre-conditioning step(s) 240. After the pre-conditioning step(s) 240, the step 250 of coating the individual pieces with a particulate coating on at least one surface of the chewing gum piece may be performed. With reference to FIG. 3, in another embodiment, the step 340 of forming the chewing gum pieces may occur after the chewing gum composition has been subjected to the pre-conditioning step 330, but prior to the step 350 of applying the particulate coating to the individual chewing gum pieces. In still other embodiments, the chewing gum pieces may be formed after the chewing gum composition has been subjected to the pre-conditioning step, and after the particulate coating has been applied to at least one surface of the chewing gum composition. Other variations of the steps are contemplated.

The particulate coating composition may be applied to the surface or surfaces of the chewing gum composition after the pre-conditioning has been completed. The particulate coating composition may be applied to the desired surface of the chewing gum composition by any means desired, including panning, dipping, spraying, rolling, brushing, or combinations thereof. Optionally, if desired, after the step of applying the particulate coating composition has been completed, a further step of applying pressure to the particulate coated surface may be used.

### EXAMPLES

### Example 1

### Particulate Coating Composition

The particulate coating composition is prepared by combining the components as set forth in Examples A-E in Table 1. The amounts included are based on the weight percent of the total coating composition.

TABLE 1
Coating Composition

| | % by weight | | | | |
|---|---|---|---|---|---|
| Components | A | B | C | D | E |
| Sugar | 75-85 | 75-85 | | | 75-85 |
| Polyol | | | 75-85 | 75-85 | |
| Free Lactic | 5-15 | 5-15 | 5-15 | 5-15 | |
| Acid | | | | | |
| Free Tartaric | 1-3 | 1-3 | 1-3 | 1-3 | 1-3 |
| Acid | | | | | |
| Free Fumaric | | | 1-3 | | |
| Acid | | | | | |
| Free Malic | | | | 2-5 | |
| Acid | | | | | |
| Encapsulated | | 3-5 | | | |
| Malic Acid¹ | | | | | |
| Encapsulated | 3-5 | | | 3-5 | |
| Tartaric Acid² | | | | | |
| Encapsulated | | | | | 3-5 |
| Citric Acid⁶ | | | | | |
| Encapsulated | | 5-15 | | | |
| Lactic & Malic | | | | | |
| Acid³ | | | | | |
| Encapsulated | | | 0.05-1 | | |
| APM⁴ | | | | | |
| Free Ace-K | | | 0.05-1 | | |
| Encapsulated | | | | 0.5-3 | |
| Ace-K & Malic | | | | | |
| Acid⁵ | | | | | |

¹Encapsulated malic acid includes 90% malic acid encapsulated in hydrogenated vegetable oil made by spray chilling with an average particle size of 100 microns.
²Encapsulated tartaric acid includes 25% tartaric acid encapsulated in maltodextrin made by spray drying with an average particle size of 50 microns.
³Encapsulated lactic & malic acid includes 75% of a blend of lactic and malic acids encapsulated together in isomalt made by mixing the acid blend into isomalt and allowing the mixture to cool and then grinding to an average particle size of 200 microns.
⁴Encapsulated APM includes 35% aspartame encapsulated in polyvinyl acetate by mixing the APM into molten PVA and extruding the mixture into strands which are chopped to provide an average particle size of 60 microns.
⁵Encapsulated Ace-K and malic acid includes 10% Ace-K and malic acid encapsulated in maltodextrin by mixing the Ace-K and malic acid with a hydrated maltodextrin and extruding the mixture into a bath of alcohol with grinding so that it solidifies into particles with an average particle size of 250 microns.
⁶Encapsulated citric acid includes 90% citric acid encapsulated in hydrogenated vegetable oil made by spray chilling with an average particle size of 100 microns.

The molding composition is prepared by combining components set forth in Examples F-H in Table 2. The amounts are based on weight percent of the total molding composition.

TABLE 2
Molding Composition

| | % by weight | | |
|---|---|---|---|
| Components | F | G | H |
| Starch | 50-95 | 50-95 | 100 |
| Sucrose | 5-50 | | |
| Erythritol | | 5-50 | |

Molding compositions F-H can be used to form the confectionery or chewing gum compositions (with or without center filling). Molding compositions F-H are dry mixed and dried to a desired moisture level and placed in a tray or mold. Impressions of a desired shape are then stamped into the molding composition. Any of the chewing gum compositions of Table 6 or confectionery compositions of Table 5 may be filled into the resulting impression. For example, it may be advantageous to fill one chewing gum composition into molds formed by making impressions with molding composition G to aid in the formation of an intrinsic moisture resistant barrier layer. Similarly, it may be advantageous to fill a confectionery composition into molds formed by making impressions with molding composition G to aid in the formation of an intrinsic moisture resistant barrier layer. After the chewing gum or confectionery composition reaches the desired firmness, the chewing gum or confectionery may be separated from the molding composition and further processed.

The aqueous wetting syrup is prepared by combining components set forth in Examples H and I in Table 3. The amounts are based on weight percent of the total aqueous wetting syrup composition.

TABLE 3
Aqueous Wetting Syrups

% by weight

| Components | I | J |
|---|---|---|
| Dextrin | 5-30 | |
| Sugar | 20-60 | 20-60 |
| Water | 20-60 | 20-60 |
| Water-based Shellac | | 5-60 |
| Hydrocolloid | | 0.01-5 |

The aqueous wetting syrup of Example I is prepared by heating the water to at least 35° C., then adding the dextrin and sugar to the water. The temperature is maintained at about 35° C. and the combination of dextrin, sugar and water is mixed until homogenous, creating the wetting syrup. The wetting syrup is then applied to the surface of the confectionery or chewing gum composition by atomized spray. In alternative methods, the syrup may be applied by enrobing based methods, tumbling, dipping and/or painting. The wetted confectionery or chewing gum composition is then dried under ambient or drying conditions until the surface of the wetted confectionery or chewing gum composition reaches a desired tackiness. A coating composition as described above is then applied to the surface of the wetted confectionery or chewing gum. The coated confectionery or chewing gum composition is then dried and packaged.

The aqueous wetting syrup of Example J is prepared by heating the water to about 20° C.-80° C., then adding the water-based shellac, sugar and hydrocolloid. The combination of water-based shellac, sugar, hydrocolloid and water is mixed until homogenous, creating the wetting syrup. The wetting syrup is then applied to the surface of the confectionery or chewing gum composition by atomized spray. In alternative methods, the syrup may be applied by enrobing based methods, tumbling, dipping and/or painting. The wetted confectionery or chewing gum composition is then dried under ambient or drying conditions until the surface of the wetted confectionery or chewing gum composition reaches a desired tackiness. A coating composition as described above is then applied to the surface of the wetted confectionery or chewing gum. The coated confectionery or chewing gum composition is then dried and packaged.

The aqueous wetting syrups described herein may be optionally applied to any of the confectionery or chewing gum compositions described below.

The non-aqueous wetting syrup is prepared by combining components set forth in Examples K-N in Table 4. The amounts are based on weight percent of the total non-aqueous wetting syrup composition.

TABLE 4
Non-Aqueous Wetting Syrups

% by weight

| Components | K | L | M | N |
|---|---|---|---|---|
| Resin | 5-40% | 0 | 0-20% | 0 |
| Fat | 0 | 0-40% | 0-20% | 0-100% |
| Wax | 0 | 0-40% | 0-20% | 0-100% |
| Liquid oil | 60-90% | 0-60% | 0-40% | 0 |
| Water | 0-5% | 0 | 0 | 0 |

The non-aqueous wetting syrups of Examples K-N are prepared by heating the ingredient having the largest % by weight to at least 35° C., then adding the remaining ingredients to the ingredient having the largest % by weight. The temperature is maintained at about 35° C. and the combination mixed until homogenous, creating the wetting syrup. The wetting syrup is applied to the surface of the confectionery or chewing gum composition by atomized spray. In alternative methods, the wetting syrup may be applied by enrobing based methods, tumbling, dipping and/or painting. The wetted confectionery or chewing gum composition is then dried under ambient or drying conditions until the surface of the wetted confectionery or chewing gum composition reaches a desired tackiness. A coating composition as described above is then applied to the surface of the wetted confectionery or chewing gum. The coated confectionery or chewing gum composition is then dried and packaged.

A solvent based shellac is also used as a wetting syrup. The wetting syrup is applied to the surface of the confectionery or chewing gum composition by atomized spray. In alternative methods, the wetting syrup may be applied by enrobing based methods, tumbling, dipping and/or painting. The wetted confectionery or chewing gum composition is then dried under ambient or drying conditions until the surface of the wetted confectionery or chewing gum composition reaches a desired tackiness. A coating composition as described above is then applied to the surface of the wetted confectionery or chewing gum. The coated confectionery or chewing gum composition is then dried and packaged.

The non-aqueous wetting syrups described herein may be optionally applied to any of the confectionery or chewing gum compositions described below.

### Example 2

### Particulate Coated Confectionery Composition

The particulate coated gummy candy composition is prepared by combining the components as set forth in Examples O-R in Table 5. The amounts are based on the weight percent of the total gummy candy composition.

TABLE 5
Gummy Candy Confectionery Composition

| | % by weight | | | |
|---|---|---|---|---|
| Components | O | P | Q | R |
| Corn Syrup | | | 18.00-22.00 | 19.00-20.00 |
| Starch | 9.00-12.00 | 10.00-10.50 | 9.00-12.00 | 10.00-10.50 |
| Invert Sugar | | | 18.00-22.00 | 19.50-20.50 |
| Sugar | | | 35.00-39.00 | 36.50-37.50 |
| Polyol | 71-83 | 75-78 | | |
| Water | q.s. | q.s. | q.s. | q.s. |
| Flavor | 0.00-2.00 | 0.00-2.00 | 0.00-1.00 | 0.00-2.00 |
| Color | 0.00-2.00 | 0.00-2.00 | 0.00-1.00 | 0.00-2.00 |

Any of the particulate coating compositions of Examples A-E are applied to the exterior of any of the gummy candy confectionery compositions described in Examples O-R. The confectionery composition is present in an amount from about 70% by weight to about 90% by weight of the total composition and the particulate coating composition is added in an amount from about 5% by weight to about 15% by weight of the total composition.

The molding compositions or wetting compositions as described above may be optionally applied to any of the chewing gum compositions described above.

### Example 3

### Chewing Gum Composition with Acidic Particulate Coating

The chewing gum composition is prepared by combining the components as set forth in S-Z in Table 6 (chewing gum compositions) and A-E in Table 1 (coating compositions). If desired, one or more of the wetting syrups in Tables 3-4 may be used.

The gum composition is prepared by combining the components as set forth in Examples S-Z in Table 6. The amounts included are based on the weight percent of the total chewing gum composition.

TABLE 6
Chewing Gum Composition

| | % by weight | | | | | | | |
|---|---|---|---|---|---|---|---|---|
| Component | S | T | U | V | W | X | Y | Z |
| Gum base* | 28-42 | 28-42 | 28-42 | 28-42 | 28-42 | 28-42 | 28-42 | 28-42 |
| Lecithin | 0.25 | 0.25 | 0.05 | 0.05 | 0.05 | 0.05 | 0.05 | 0.05 |
| Maltitol | 52-55 | 45-50 | 0 | 50-54 | 52-57 | 45-55 | 47-52 | 0 |
| Sorbitol | 0 | 0-10 | 0 | 0-5 | 0-5 | 5-10 | 0-5 | 0 |
| Lycasin ™ | 0 | 0 | 0 | 0.25 | 0.25 | 0.25 | 0.25 | 0 |
| Erythritol | 0 | 0 | 15-30 | 0 | 0 | 0 | 0 | 0 |
| Sugar | 0 | 0 | 2-15 | 0 | 0 | 0 | 0 | 2-15 |
| Corn Syrup | 0 | 0 | 2-15 | 0 | 0 | 0 | 0 | 2-15 |
| Flavors | 2.50 | 2.50 | 2.26 | 2.26 | 2.26 | 2.50 | 2.50 | 2.50 |
| Cooling | 0.08 | 0.08 | 0 | 0 | 0 | 0.08 | 0.08 | 0.08 |
| Agent | | | | | | | | |
| Acidulants | 1.2 | 1.2 | 0 | 0 | 0 | 1.2 | 1.2 | 1.2 |
| Intense | 3.40 | 3.40 | 1.70 | 3.40 | 3.40 | 3.40 | 3.40 | 0 |
| sweetener | | | | | | | | |

*gum base may include 3% to 11% by weight of a filler such as, for example, talc, dicalcium phosphate, and calcium carbonate (the amount of filler in the gum base is based on the weight percent of the gum region composition, for example, in the above compositions S-Z, if a gum region composition includes 5% filler, the amount of gum base will be 5% less than the range recited in the table, i.e., from 23-37%)

The compositions for the chewing gums are prepared by first combining talc, where present, with the gum base under heat at about 85° C. This combination is then mixed with the bulk sweeteners, lecithin, and sweetener syrups for six minutes. The flavor blends which include a pre-mix of the flavors and cooling agents are added and mixed for 1 minute Finally, the acids and intense sweeteners are added and mixed for 5 minutes.

Any of the coating compositions of Examples A-E are applied to the exterior of any of the chewing gum compositions of S-Z as described above. The chewing gum composition is added in an amount from about 85% by weight to about 95% by weight of the total composition and the coating is added in an amount from about 5% by weight to about 15% by weight of the total composition.

The molding compositions or wetting compositions as described above may be optionally applied to any of the chewing gum compositions described above.

What is claimed is:

1. A method of preparing a particulate coated confectionery product comprising the steps of:
a. providing a confectionery composition having a surface;
b. applying a surface treatment comprising a non-aqueous binder treatment to said surface; and
c. applying a particulate coating composition to said surface-treated confectionery composition.

2. The method of claim 1, wherein said surface treatment is applied to the entire surface of said confectionery composition.

3. The method of claim 1, further comprising a drying step prior to said step of applying said particulate coating composition, wherein said drying step comprises drying said surface-treated confectionery composition for about 30 to about 60 seconds.

4. The method of claim 1, wherein said particulate coating comprises a sweetener and a food acid.

5. The method of claim 1, wherein said particulate coating has an average particle size of about 10-200 microns.

6. The method of claim 1, wherein said applying a surface treatment step includes an application method selected from the group consisting of spraying, enrobing, painting, panning, dipping, screw conveying, and combinations thereof.

7. The method of claim 1, further comprising the step of forming individual confectionery pieces.

8. The method of claim 7, wherein said individual confectionery pieces are in the shape of a pellet, slab, cylinder, chunk, pellet, ball, rope or string.

9. The method of claim 7, wherein said forming step occurs prior to said surface treatment application step.

10. The method of claim 7, wherein said forming step occurs after said surface treatment application step.

11. The method of claim 7, wherein said forming step occurs prior to said particulate coating composition application step.

12. The method of claim 7, wherein said forming step occurs after said particulate coating composition application step.

13. The method of claim 7, wherein said forming step is selected from the group consisting of extrusion, rolling, scoring, rope cutting, and combinations thereof.
